(19) United States
(12) Patent Application Publication
(10) Pub. No.: US 2008/0295550 A1
(43) Pub. Date: Dec. 4, 2008

(54) Door Lock, Especially Comprising a Panic Function

(75) Inventor: Axel Schmidt, Ennepetal (DE)

Correspondence Address: COHEN, PONTANI, LIEBERMAN & PAVANE LLP, 551 FIFTH AVENUE, SUITE 1210, NEW YORK, NY, 10176, US

(73) Assignee: DORMA GMBH & CO., KG, ENNEPETAL (DE)

(21) Appl. No.: 11/659,310

(22) PCT Filed: Aug. 2, 2005
(86) PCT No.: PCT/EP05/08355

§ 371 Date: Feb. 2, 2007

(51) Int. Cl. E05B 55/00

(52) U.S. Cl. 70/144

(57) ABSTRACT

A door lock for mounting on a door leaf, comprising a housing having a front side; a latch bolt disposed in the housing and adjacent to the front side of the housing, the latch bolt being movable between a first position where the latch bolt projects out from the front side of the housing and a second position where the latch bolt is retracted into the housing; a spring preloading the latch bolt into the first position; a connecting device; and a drive device comprising an electric motor comprising a motor shaft, the motor shaft being coupled to the latch bolt by the connecting device so that when the electric motor is actuated, rotation of the motor shaft causes the latch bolt to move into the second position.

The invention relates to a door lock according to the generic part of claim 1, which is in particular provided with an anti-panic function.

Such a door lock is known from U.S. Pat. No. 3,854,763. The latch bolt of this door lock is connected to an electro-magnet and to a so-called anti-panic bar via a complicated lever gear. When activated, the electromagnet, via the lever gear, can swing back the latch bolt into the door lock housing. This swinging back can be realized by the anti-panic bar via a lever gear as well, which is connected to the latch bolt.

The main drawback of this prior art door lock design resides in the enormous expense for two different lever gears, which, on the one hand, are complicated to manufacture and, on the other hand, are susceptible to failure.

Therefore, it is an object of the present invention to provide a door lock of the type described in the generic part of patent claim 1, which in particular is equipped with an anti-panic function, has a considerably simplified structure and has an improved operational reliability.

This object is achieved by the features of patent claim 1.

One of the particular advantages of the inventive door lock is that the lever gear provided in the state of the art for retracting the latch bolt can be substituted by a simple flexible connecting device, which, in a particularly preferred embodiment, can be executed as a wire, a cable or as a Bowden cable. The overall construction is thus considerably simplified, because such a component can be retrofitted without any problem.

Pre-loading the latch bolt into the closed position can be preferably realized by a simple spring, which likewise reduces the total expenditure of the construction considerably.

In a known manner, such a door lock can be provided with an anti-panic function , which for example has an anti-panic bar, which can be pushed into the door lock housing in the direction of movement exerted by an operator and can retract the latch bolt into the door lock housing via a lever gear, for example. In this regard, an arrangement may be chosen as the one known from U.S. Pat. No. 3,854,763, which disclosure content is herewith fully incorporated by reference in the disclosure content of the present application.

Advantageous further developments of the invention are set forth in the dependent claims.

Further details, features and advantages of the invention will become apparent from the following description of exemplary embodiments, reference being made to the figures, in which:

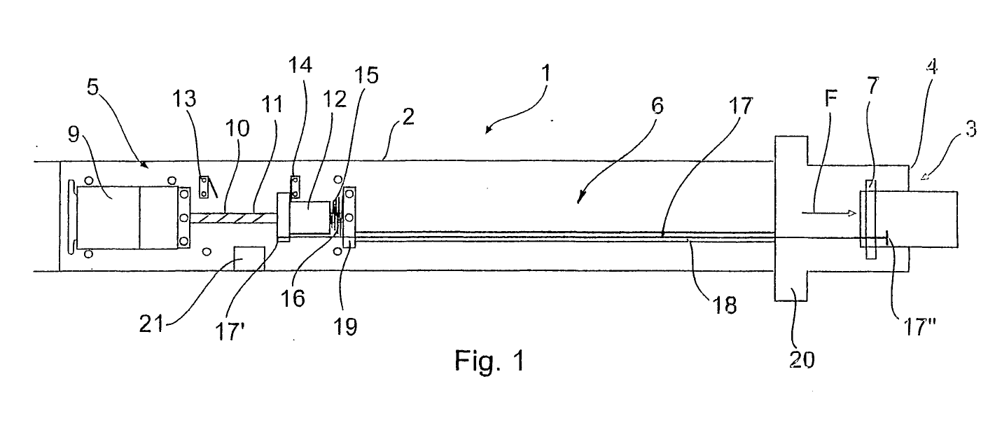

FIG. 1 shows a diagrammatically very simplified illustration of a first embodiment of the inventive door lock, the latch bolt thereof being disposed in the projected position,

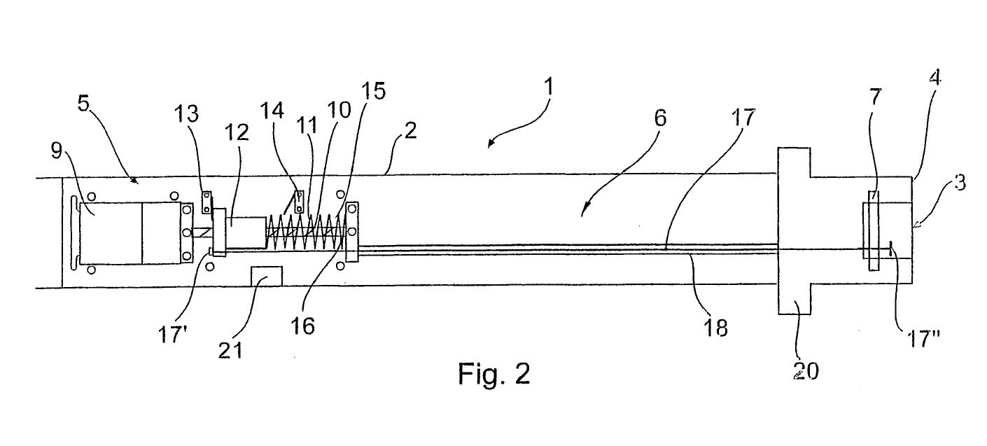

FIG. 2 shows an illustration of the door lock corresponding to FIG. 1, with the latch bolt being swung inwards.

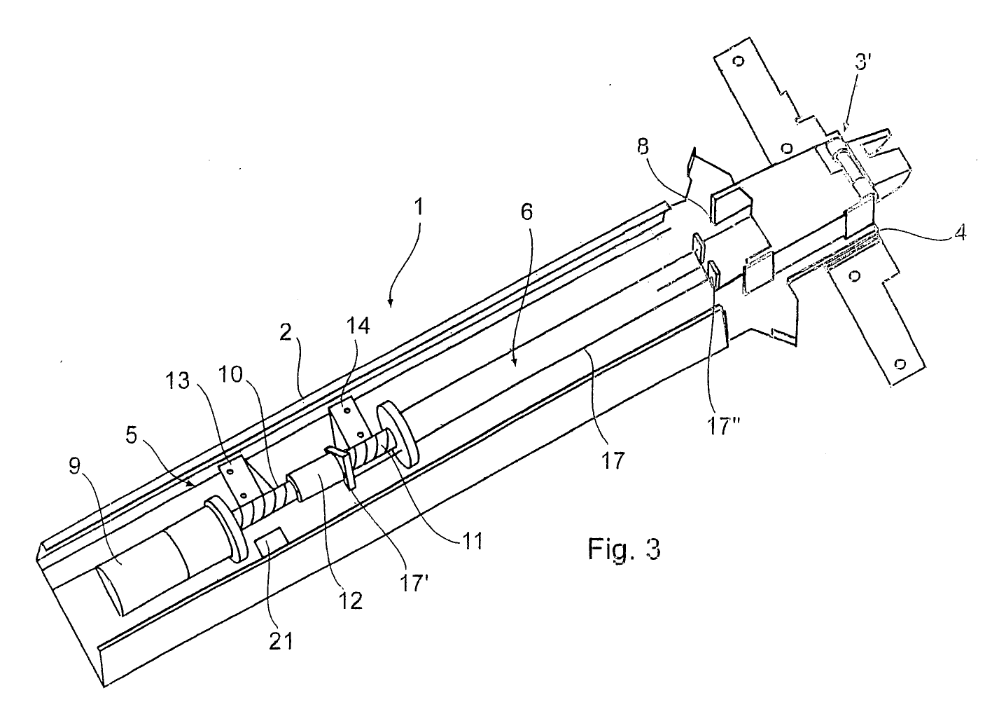

FIG. 3 shows a diagrammatically simplified perspective illustration of a second embodiment of the inventive door lock with the latch bolt protruding from the door lock housing, and

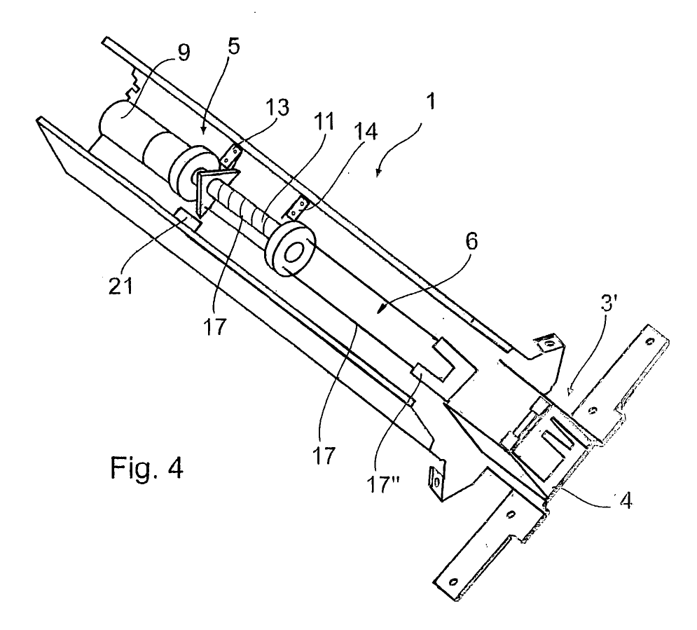

FIG. 4 shows an illustration corresponding to FIG. 3 of the second embodiment of the inventive door lock, with the latch bolt being moved back into the door lock housing.

A first embodiment of the inventive door lock 1 is illustrated in FIGS. 1 and 2. It can be equipped with a regular anti-panic function, which, however, is not relevant for the explanation of the principles of the present invention, and therefore it is not illustrated in the Figures. As a rule, such a door lock 1 is mounted onto the door leaf. Thus, appropriate doors can be retrofitted later with such a lock.

The door lock 1 has a door lock housing 2. A latch bolt 3 is disposed at a front side 4 within the door lock housing 2 and is movable between a projected position visible in FIG. 1 and a retracted position visible in FIG. 2.

Furthermore, the door lock 1 has a drive means 5, by means of which, when actuated, the latch bolt 3 is retractable into the door lock housing 2. For this purpose, the latch bolt 3 is connected to the drive means 5 via a connecting device 6.

In the position protruding from the door lock housing 2, illustrated in FIG. 1, into which the latch bolt 3 is pre-loaded by means of a spring, symbolized in FIG. 1 by the arrow F, the door equipped with the inventive door lock 1 is closed.

If the drive means 5 having an electric motor 9 is powered, the latch bolt 3 can be moved back into the door lock housing 2 against the force of the spring F.

In the embodiment illustrated in FIGS. 1 and 2, the latch bolt 3 is pivotably supported at a pivot pin 7 fixed at the housing. The latch bolt 3 can be pivoted about this pivot pin 7 between the positions illustrated in FIGS. 1 and 2. It should be noted that a displaceable latch bolt 3 can be used as well.

The drive means 5 or its electric motor 9 has a motor shaft 11, which is provided with a diagrammatically simplified illustrated thread 10. A threaded sleeve 12, which is supported against rotation in the door lock housing 2, is disposed on the motor shaft 11 provided with the thread 10. FIGS. 1 and 2 furthermore show limit switches 13 and 14 delimiting the displacement path of the threaded sleeve 12. For this purpose, in FIG. 1, the threaded sleeve 12 actuates the limit switch 14 and, in FIG. 2, the threaded sleeve 12 actuates the limit switch 13 disposed adjacent the motor 9, such that the end positions of the threaded sleeve 12 are determined, because the motor 9 is respectively shut off when the limit switches 13 and 14 are actuated.

Furthermore, a damping spring 15 is disposed around the motor shaft 11, which spring adjacent one end of the motor shaft 11 is placed around the latter, this end 16 representing the end of the motor shaft 11 opposite the electric motor 9. In this case, as shown in FIGS. 1 and 2, the damping spring 15 is bearing against a first support 19 fixed at the housing, which support is disposed again adjacent the end 16.

Furthermore, the door lock housing 2 has a second support 20 placed adjacent the front side 4. Between these two supports 19 and 20, a tube-shaped hollow guiding sleeve 18 is disposed, wherein the connecting device 6, preferably in the shape of a flexible wire or cable, partially extends, as is revealed in detail in the illustration of FIGS. 1 and 2.

At one of its ends 23 the cable or the wire 17 is connected to the threaded sleeve 12 and at the other end 22 to the latch bolt 3, such that, when retracting the threaded sleeve 12 into the position according to FIG. 2, the latch bolt 3 can be pivoted about the pivot pin 7 into the door lock housing 2. This is established in the combined views of FIGS. 1 and 2.

Furthermore, a control equipment diagrammatically indicated by block 21 for controlling or regulating the inventive door lock 1 is provided, which in particular has a timing device for controlling or regulating the pole reversal and thus the direction of rotation of the electric motor 9. When the threaded sleeve 12 is moved back from the position illustrated in FIG. 1 into the position illustrated in FIG. 2, it will actuate the switch 13, effecting the pole reversal and thus the direction of rotation of the electric motor 9 after an adjustable period of time. This may consequently mean that, depending on the set period of time, the latch bolt 3 may continue to remain in the door lock housing 2 in the swung back position. If the latch bolt is to be pivoted again into the position illustrated in FIG. 1, the motor is actuated again by the control equipment 21 and thus, on account of its pole reversal previously made, moves the threaded sleeve 12 from the position of FIG. 2 into the one of FIG. 1, such that the latch bolt 3, by means of the force of the spring F, can be pivoted back into the projected position according to FIG. 1, without the connecting device 6 interfering with this pivoting movement.

A second embodiment of the inventive door lock 1 is illustrated in FIGS. 3 and 4. All parts and functions, which correspond to those of FIGS. 1 and 2, have the same reference numerals, such that reference is made to the above explanations for their disposition and functioning.

The difference between the two embodiments is that in the second embodiment the latch bolt 3′ is disposed at a slide 8, which is loaded again by the force of a spring F, such that, according to the illustration of FIG. 3, the latch bolt protrudes from the door lock housing 2, if the threaded sleeve 12 is located in abutment against the limit switch 14.

If the latch bolt is to be retracted, the electric motor 9 is actuated and, in this case, the wire or the cable 17, which in this case is connected to the slide 8 with its end 22, pulls the slide 8 and thus the latch bolt 3′ back into the housing, as is revealed in FIG. 4.

In this embodiment as well the pole reversal is again done in this position after an adjustable period of time, such that as already explained above, it is possible to retract the latch bolt 3′ into the position according to FIG. 3.

The control or the regulation 21 could be actuated as well by a switching command from a central station or the like. An activation of the control or the regulation 21 is likewise possible by a manual push-button besides or in front of the door, this is particularly relevant for disabled persons to allow them a free passing through the door.

The drive unit 5 including the control or the regulation could be retrofitted into a lock of the species described above.

In addition to the above described automatic actuation, opening the door is always possible in particular via the anti-panic bar.

### List of References

1 door lock
2 door lock housing
3 latch bolt
3′ latch bolt
4 front side
5 drive means
6 connecting device
7 pivot pin fixed at the housing
8 slide
9 electric motor
10 thread
11 motor shaft
12 threaded sleeve
13 limit switch
14 limit switch
15 damping spring
16 end
17 cable, wire, Bowden cable
18 guiding sleeve
19, 20 first and second support
21 control equipment
22 end of cable
23 end of cable
F spring

1-13. (canceled)

14. A door lock for mounting on a door leaf, comprising:
a housing having a front side;
a latch bolt disposed in the housing and adjacent to the front side of the housing, the latch bolt being movable between a first position where the latch bolt projects out from the front side of the housing and a second position where the latch bolt is retracted into the housing;
a spring preloading the latch bolt into the first position;
a connecting device; and
a drive device comprising an electric motor coupled to the latch bolt by the connecting device so that when the electric motor is actuated, rotation of the electric motor causes the latch bolt to move into the second position.

15. The door lock of claim 14, further comprising a pivot pin supported by the housing, the latch bolt being pivotably supported by the pivot pin so that the latch bolt is pivotably movable between the first position and the second position.

16. The door lock of claim 14, further comprising a slide disposed in the housing and adjacent to the front side of the housing and movable between the first position and the second position, the latch bolt being disposed on the slide.

17. The door lock of claim 14, wherein the electric motor comprises a threaded motor shaft, the door lock further comprising a threaded sleeve which threadedly engages the motor shaft, the threaded sleeve being fixed with respect to rotation relative to the housing.

18. The door lock of claim 17, further comprising two spaced limit switches disposed in the housing for limiting movement of the threaded sleeve relative to the motor shaft.

19. The door lock of claim 17, further comprising a damping spring pro-loading the threaded sleeve toward the electric motor.

20. The door lock of claim 14, wherein the connecting device comprises a flexible wire or cable.

21. The door lock of claim 20, wherein the connecting device further comprises a guiding sleeve, the flexible wire or cable extending through the guiding sleeve.

22. The door lock of claim 21, the housing further comprising a first support disposed proximate the drive device and a second support disposed adjacent to the front side of the housing, the guiding sleeve extending between the first support and the second support.

23. The door lock of claim 20, wherein the electric motor comprises a threaded motor shaft, the door lock further comprising a threaded sleeve which threadedly engages the motor shaft, the threaded sleeve being fixed with respect to rotation relative to the housing, the flexible wire or cable having a first end attached to the threaded sleeve, and a second end attached to the latch bolt.

24. The door lock of claim 16, wherein the electric motor comprises a threaded motor shaft, the door lock further comprising a threaded sleeve which threadedly engages the motor shaft, the threaded sleeve being fixed with respect to rotation relative to the housing, the connecting device comprising a flexible wire or cable having a first end attached to the threaded sleeve, and a second end attached to the slide.

25. The door lock of claim 14, further comprising a control unit coupled to the electric motor for controlling or changing a rotation direction of the electric motor.

26. The door lock of claim 26, wherein each of the electric motor, the connecting device and the control unit is retrofitable into a conventional door.
